(19) United States
(12) Patent Application Publication
(10) Pub. No.: US 2012/0087594 A1
(43) Pub. Date: Apr. 12, 2012

(54) IMAGE-ENCODING APPARATUS AND IMAGE-DECODING APPARATUS FOR EFFICIENTLY TRANSMITTING A LARGE CAPACITY IMAGE

(76) Inventors: Jin Young Lee, Yongin-si (KR); Jae Joon Lee, Yongin-si (KR); Ho Cheon Wey, Yongin-si (KR)

(21) Appl. No.: 13/377,437

(22) PCT Filed: Jun. 8, 2010
(86) PCT No.: PCT/KR2010/003652

§ 371 Date: Dec. 9, 2011

(30) Foreign Application Priority Data
Jun. 9, 2009 (KR) 1020090050832
Feb. 3, 2010 (KR) 102010009899

(51) Int. Cl. G06K 9/36

(52) U.S. Cl. 382/233; 382/232; 382/238; 382/250; 382/251

(57) ABSTRACT

Disclosed are an image-encoding apparatus and an image-decoding apparatus for efficiently transmitting a large capacity image. The image encoding apparatus separates an input image into pixel units to generate real images of a first region and of a second region, performs a predictive filtering process on the real image of the first region to generate a predictive image of the second region, and differentiates the predictive image of the second region from the real image of the second region to thereby efficiently reduce the volume of data prior to encoding the input image.

### TECHNICAL FIELD

Example embodiments relate to an apparatus and method of encoding and decoding an image, and more particularly, to an image encoding apparatus and method and an image decoding apparatus and method that may transmit a large volume image efficiently.

### BACKGROUND ART

In accordance with recent developments in imaging technology, research on an Ultra High Definition Television (UHDTV) and a three-dimensional television (3D TV) is being conducted actively. In many nations, various broadcasting services have already been provided using a high-definition television (HDTV), that is, a high-resolution TV. However, in order to satisfy desires of customers for a clearer and more natural image on a larger screen, preparations for the UHDTV corresponding to a next generation broadcasting service following the HDTV are being made. Also, in accordance with increasing desires of customers for conversational and tangible contents, a demand for a 3D TV using multi-viewpoint imaging technology that is one field of 3D image processing technology that is also increasing.

According to a change in demands of the customers, an importance of the UHDTV and the 3D TV is increasing. However, the UHDTV corresponding to a size sixteen times greater than an HD screen, and the 3D TV using at least two images with respect to a single viewpoint bring about an increase in an amount of data and thus, a problem arises when the data is encoded using a conventional image compression scheme. In order to successfully provide UHDTV and 3D TV services, there is a desire for a method of encoding and decoding large volume image data efficiently.

### DISCLOSURE OF INVENTION

### Technical Solutions

According to example embodiments, there is provided an image encoding apparatus including an image separating unit to generate a real image of a first region and a real image of a second region different from the first region, in pixel units, with respect to the input image, an image filtering unit to generate a predictive image of the second region by performing predictive filtering on the real image of the first region using a predictive filter, an image generating unit to generate a differential image of the second region, using the predictive image of the second region and the real image of the second region, and an image encoding unit to encode the real image of the first region, the differential image of the second region, and filter coefficients of the predictive filter.

According to other example embodiments, there is provided an image encoding apparatus including an image separating unit to generate a real image of a first region and a real image of a second region different from the first region, in pixel units, with respect to the input image, an image filtering unit to generate a predictive image of the second region, by performing predictive filtering on the real image of the first region using a predictive filter, an image generating unit to generate a differential image of the second region, using the predictive image of the second region and the real image of the second region, and an image encoding unit to perform encoding by applying quantization offsets to the real image of the first region, the differential image of the second region, and filter coefficients of the predictive filter.

According to still other example embodiments, there is provided an image encoding apparatus including a predictive mode determining unit to determine an optimal predictive mode for an input image among a first predictive mode for performing prediction by extending an upper reference pixel in a vertical direction, a second predictive mode for performing prediction by extending a left reference pixel in a horizontal direction, a third predictive mode for performing prediction using an average of the upper reference pixel and the left reference pixel, a fourth predictive mode for not performing prediction, and a fifth predictive mode for not performing compression, and to perform prediction for the input image based on the determined optimal predictive mode, a discrete cosine transform (DCT) transformation unit to transform data of the input image on which the prediction is performed, from a spatial domain to a frequency domain, a quantization unit to quantize a coefficient calculated through the DCT transformation, and an entropy encoding unit to entropically encode the coefficient quantized by the quantization unit to convert the coefficient into a bit stream.

According to yet other example embodiments, there is provided an image decoding apparatus including an image decoding unit to decode a real image of a first region, a differential image of a second region different from the first region, and filter coefficients of a predictive filter, with respect to an encoded input image, an image filtering unit to generate a predictive image of the second region by performing predictive filtering on the real image of the first region, an image generating unit to generate a combined image of the second region, using the predicative image of the second region and the differential image of the second region, and an image combining unit to generate an original input image by combining the real image of the first region and the combined image of the second region.

According to still other example embodiments, there is provided an image decoding apparatus including an image decoding unit to decode a real image of a first region, a differential image of a second region different from the first region, and filter coefficients of a predictive filter, with respect to an input image encoded by applying quantization offsets, an image filtering unit to generate a predictive image of the second region by performing predictive filtering on the real image of the first region, an image generating unit to generate a combined image of the second region, using the predictive image of the second region and the differential image of the second region, and an image combining unit to generate an original input image by combining the real image of the first region and the combined image of the second region.

According to yet other example embodiments, there is provided an image decoding apparatus including an entropy decoding unit to generate restoration information by entropically decoding an input bit stream, an inverse quantization unit to perform inverse quantization on the generated restoration information, a DCT inverse transformation unit to transform the inversely quantized restoration information, from a frequency domain to a spatial domain, and an image decoding unit to decode a real image and a differential image by performing prediction in a predictive mode in which an encoding process is performed, among a first predictive mode for performing prediction by extending an upper reference pixel in a vertical direction, a second predictive mode for performing prediction by extending a left reference pixel in a horizontal direction, a third predictive mode for performing prediction using an average of the upper reference pixel and the left reference pixel, a fourth predictive mode for not performing prediction, and a fifth predictive mode for not performing compression.

According to still other example embodiments, there is provided an image encoding method including generating a real image of a first region and a real image of a second region different from the first region, in pixel units, with respect to the input image, generating a predictive image of the second region by performing predictive filtering on the real image of the first region using a predictive filter, generating a differential image of the second region, using the predictive image of the second region and the real image of the second region, and encoding the real image of the first region, the differential image of the second region, and filter coefficients of the predictive filter.

According to yet other example embodiments, there is provided an image decoding method including decoding a real image of a first region, a differential image of a second region different from the first region, and filter coefficients of a predictive filter, with respect to an encoded input image, generating a predictive image of the second region by performing predictive filtering on the real image of the first region, generating a combined image of the second region, using the predicative image of the second region and the differential image of the second region, and generating an original input image by combining the real image of the first region and the combined image of the second region.

### Effect of Invention

According to example embodiments, a large volume image may be encoded efficiently by separating an input image in pixel units and performing encoding the input image excluding an image corresponding to a predetermined region.

According to example embodiments, a large volume image may be encoded efficiently by predicting an image of another region through predictive filtering from an image of a predetermined region in pixel units, and encoding an input image excluding the predicted image.

According to example embodiments, a large volume image may be encoded efficiently by generating an image of another region by decoding an input image of which only partial regions are encoded, and performing predictive filtering on images of the partial regions using a predictive filter.

### BRIEF DESCRIPTION OF DRAWINGS

FIG. 1 illustrates an image encoding apparatus according to example embodiments.

FIG. 2 illustrates an image decoding apparatus according to example embodiments.

FIG. 3 illustrates a process of performing encoding based on a real odd image or a real even image according to example embodiments.

FIG. 4 illustrates a process of performing encoding based on a real odd image or a real even image according to other example embodiments.

FIG. 5 illustrates a process of performing decoding based on a real odd image or a real even image according to example embodiments.

FIG. 6 illustrates an image encoding apparatus according to other example embodiments.

FIG. 7 illustrates an image decoding apparatus according to other example embodiments.

FIG. 8 illustrates a process of generating a differential even image from a real odd image according to example embodiments.

FIG. 9 illustrates a process of generating a differential odd image from a real even image according to example embodiments.

FIG. 10 illustrates a process of generating a differential even image from a real odd image according to other example embodiments.

FIG. 11 illustrates a process of generating a differential odd image from a real even image according to other example embodiments.

FIG. 12 illustrates an image encoding method according to example embodiments.

FIG. 13 illustrates an image decoding method according to example embodiments.

FIG. 14 illustrates an image encoding method according to other example embodiments.

FIG. 15 illustrates an image decoding method according to other example embodiments.

### BEST MODE FOR CARRYING OUT THE INVENTION

Reference will now be made in detail to example embodiments, examples of which are illustrated in the accompanying drawings, wherein like reference numerals refer to the like elements throughout. Example embodiments are described below in order to explain example embodiments by referring to the figures.

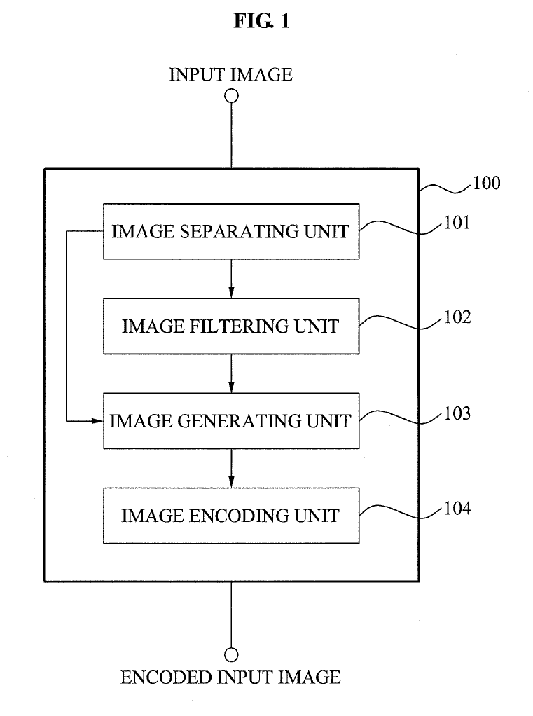

FIG. 1 illustrates an image encoding apparatus according to example embodiments.

Referring to FIG. 1, an image encoding apparatus 100 may include an image separating unit 101, an image filtering unit 102, an image generating unit 103, and an image encoding unit 104.

The image separating unit 101 may generate a real image of a first region and a real image of a second region different from the first region, in pixel units, with respect to the input image. The image encoding apparatus 100 may efficiently reduce an amount of image data before encoding large volume image data. In this instance, the first region may indicate a region to be encoded, and the second region may indicate, in advance, a region to be excluded before the input image is encoded.

For example, the image separating unit 101 may separate the input image into a real even image including pixels in even rows or even columns and a real odd image including pixels in odd rows or odd columns, with respect to the input image. When the first region corresponds to the real even image, the second region may correspond to the real odd image. When the first region corresponds to the real odd image, the second region may correspond to the real even image.

The image filtering unit 102 may generate a predictive image of the second region by performing predictive filtering on the real image of the first region using a predictive filter. Although the real image of the first region may be different from the real image of the second region in the input image, there may be an association between the real image of the first region and the real image of the second region. For example, the image filtering unit 102 may calculate a filter coefficient of the predictive filter, by which the real image of the second region may be most precisely predicted from the real image of the first region, and may generate the predictive image of the second region by applying a predictive filter to which the calculated filter coefficient is applied.

In this instance, when the pixels in the even rows or the even columns of the input image are encoded, the image filtering unit 102 may generate a predictive odd image by filtering the real even image using the predictive filter. Conversely, when the pixels in the odd rows or the odd columns of the input image are encoded, the image filtering unit 102 may generate a predictive even image by filtering the real odd image using the predictive filter.

The image generating unit 103 may generate a differential image of the second region using the real image of the second region and the predictive image of the second region. When the predictive image of the second region, predicted from the real image of the first region, is completely identical to the real image of the second region, the differential image of the second region may correspond to 0. That is, the more excellently the predictive filter performs, the closer data of the second region excluded may become to 0. Accordingly, by decoding the real image of the first region only, the second region may be almost completely restored from the real image of the first region.

For example, when the pixels in the even rows or the even columns of the input image are encoded, the image generating unit 103 may generate a differential odd image by differentiating a predictive odd image from the real odd image. Conversely, when the pixels in the odd rows or the odd columns of the input image are encoded, the image generating unit 103 may generate a differential even image by differentiating a predictive even image from the real even image.

The image encoding unit 104 may encode the input image by encoding the real image of the first region, the differential image of the second region, and the filter coefficients of the predictive filter. As mentioned in the foregoing, when the predictive image of the second region is ideally predicted from the real image of the first region, the differential image of the second region may have a value of almost 0. That is, in a case where the predictive image of the second region is ideally predicted from the real image of the first region, an effect analogous to encoding the entire image may be obtained by encoding only half of the input image. According to example embodiments, an amount of data to be encoded may be reduced efficiently using the predictive filter capable of most efficiently predicting the real image of the second region from the real image of the first region.

For example, when the pixels in the even rows or the even columns of the input image are encoded, the image encoding unit 104 may encode the real even image, the differential odd image, and the filter coefficients of the predictive filter. Conversely, when the pixels in the odd rows or the odd columns of the input image are encoded, the image encoding unit 104 may encode an actual odd image, the differential even image, and the filter coefficients of the predictive filter.

Also, the image encoding unit 104 may encode at least one of the real image of the first region, the differential image of the second region, and the filter coefficients of the predictive filter by performing intra prediction according to newly defined five predictive modes, and may apply quantization offsets to the real image of the first region, the differential image of the second region, and the filter coefficients of the predictive filter. That is, encoding using the newly defined modes may be performed on the entire image or a portion of the image input into the image encoding unit 104. For example, the real image of the first region may be encoded by performing the intra prediction according to the newly defined five predictive modes, and the differential image of the second region and the filter coefficients of the predictive filter may be encoded using a predictive mode used in the H.264/AVC standard.

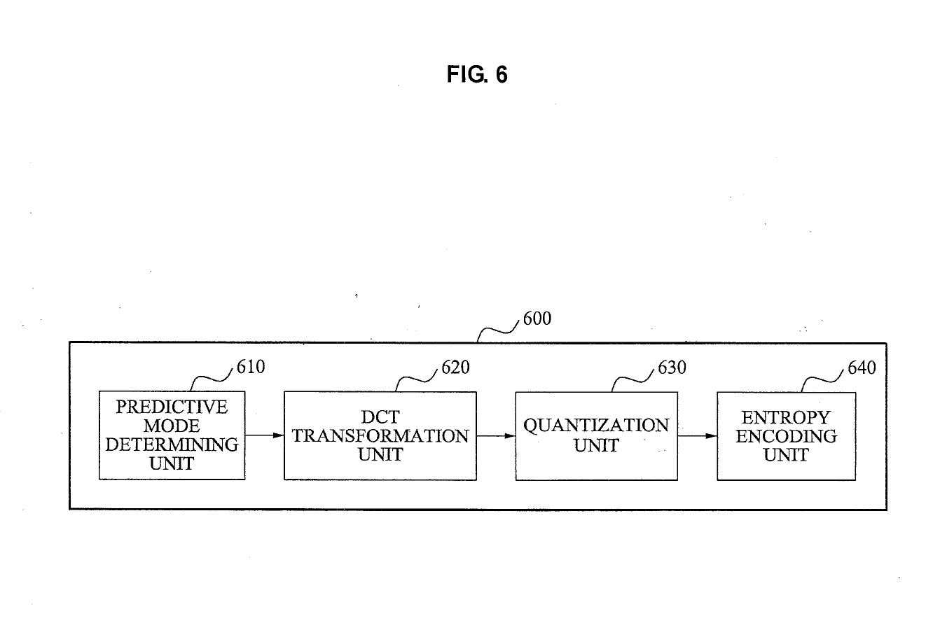

The newly defined five predictive modes and a process of performing encoding by performing the intra prediction will be further described later with reference to FIG. 6.

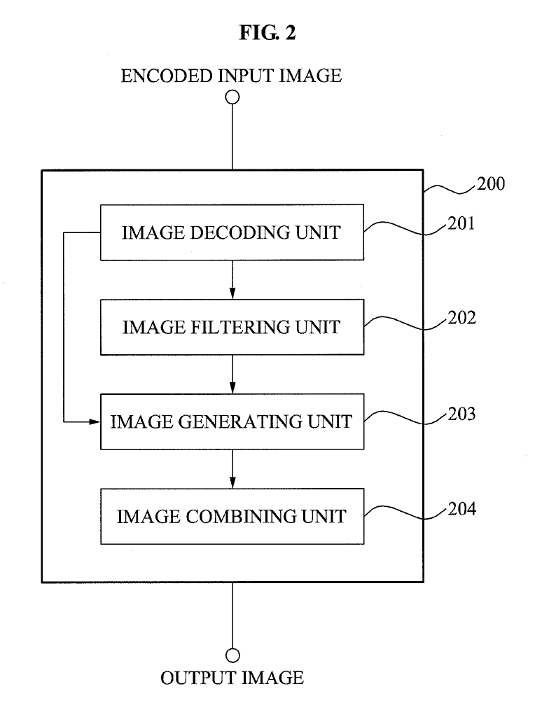

FIG. 2 illustrates an image decoding apparatus according to example embodiments.

Referring to FIG. 2, an image decoding apparatus 200 may include an image decoding unit 201, an image filtering unit 202, an image generating unit 203, and an image combining unit 204.

The image decoding unit 201 may decode a real image of a first region, a differential image of a second region different from the first region, and filter coefficients of a predictive filter, with respect to an input image. As described with reference to FIG. 1, the first region and the second region may refer to regions separated in pixel units with respect to the input image. In this instance, when the first region corresponds to even rows according the pixels, the second region may correspond to odd rows, based on the pixel units. When the first region corresponds to even columns, the second region may correspond to odd columns. Similarly, when the first region corresponds to odd rows, the second region may correspond to even rows. When the first region corresponds to odd columns, the second region may correspond to even columns.

In this instance, the more excellently the predictive filter performs, the more precisely a real image of the second region may be predicted from the real image of the first region. That is, when the performance of the predictive filter is more excellent, the differential image of the second region may be closer to 0. When the differential image of the second region generated by the image encoding apparatus 100 is relatively close to 0, the image decoding apparatus 200 may generate the entire original input image using the real image of the first region.

For example, when pixels in the even rows or the even columns of the input image are encoded, the image decoding unit 201 may decode a real even image, a differential odd image, and filter coefficients of a predictive filter. Conversely, when pixels in the odd rows or the odd columns of the input image are encoded, the image decoding unit 201 may decode a real odd image, a differential even image, and the filter coefficients of the predictive filter.

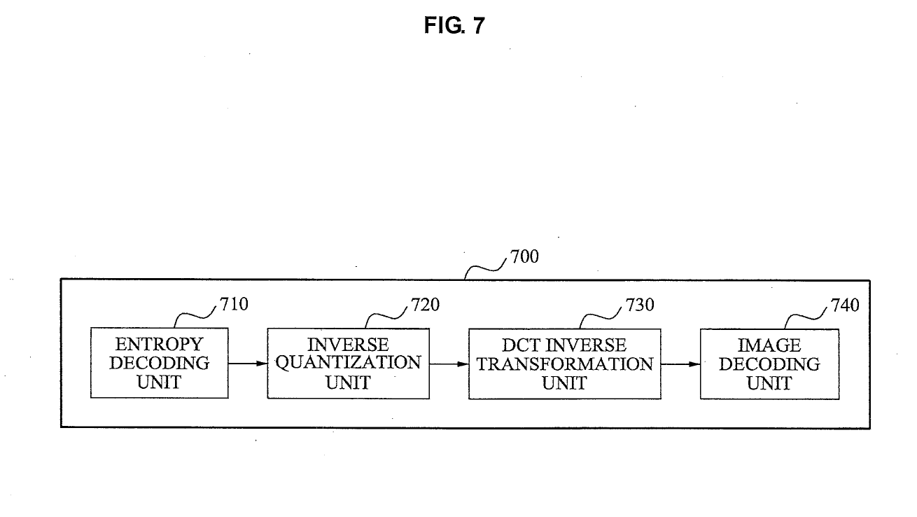

Also, the image decoding unit 201 may decode the real image of the first region, the differential image of the second region, and the filter coefficients of the predictive filter, by performing intra prediction in a predictive mode in which an encoding process is performed, among the aforementioned five predictive modes. In this instance, a process of performing decoding by performing the intra prediction in the predictive mode in which the encoding process is performed will be further described later with reference to FIG. 7.

The image filtering unit 202 may generate a predictive image of the second region by performing predictive filtering on the real image of the first region using the predictive filter. For example, when the pixels in the even rows or the even columns of the input image are encoded, the image filtering unit 202 may generate a predictive odd image by filtering the real even image using the predictive filter. Conversely, when the pixels in the odd rows or the odd columns of the input image are encoded, the image filtering unit 202 may generate a predictive even image by filtering the real odd image using the predictive filter.

The image generating unit 203 may generate a combined image of the second region, using the predictive image of the second region and the differential image of the second region. For example, when the pixels in the even rows or the even columns of the input image are encoded, the image generating unit 203 may generate a combined odd image by combining the differential odd image and the predictive odd image. Conversely, when the pixels in the odd rows or the odd columns of the input image are encoded, the image generating unit 203 may generate a combined even image by combining the differential even image and the predictive even image.

The image combining unit 204 may generate an original input image by combining the real image of the first region and the combined image of the second region. When the pixels in the even rows or the even columns of the input image are encoded, the image combining unit 204 may generate the original input image by combining the real even image and the combined odd image. Conversely, the pixels in the odd rows or the odd columns of the input image are encoded, the image combining unit 204 may generate the original input image by combining the real odd image and the combined even image.

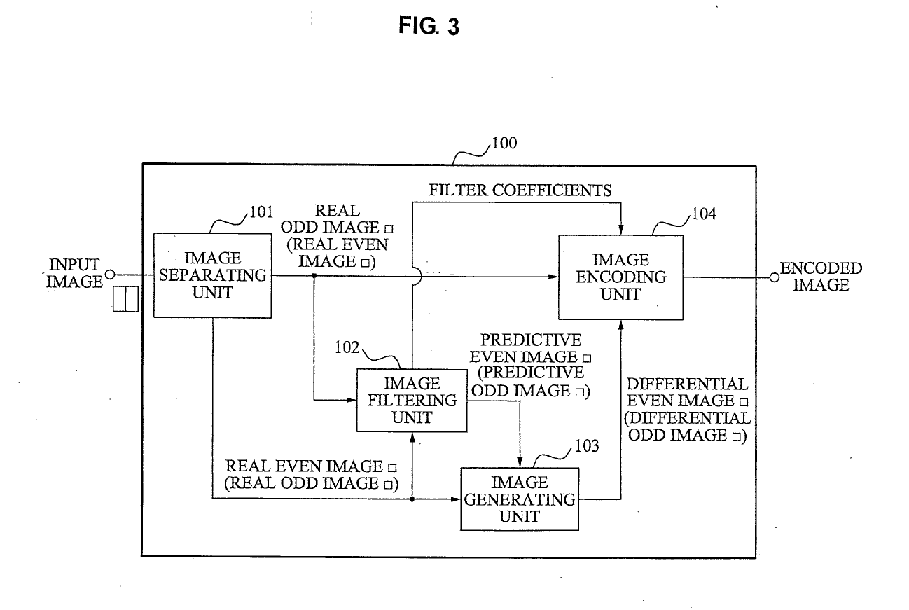

FIG. 3 illustrates a process of performing encoding based on a real odd image or a real even image according to example embodiments.

When an input image is input into an image encoding apparatus 100, an image separating unit 101 may separate the input image into a first region and a second region in pixel units. For example, the first region and the second region may correspond to a real odd image including pixels in odd rows only or a real even image including pixels in even rows only. Also, the first region and the second region may correspond to a real even image including pixels in even columns only, or a real odd image including pixels in odd columns only.

In FIG. 3, a process of encoding the input image based on the real odd image including the pixels in the odd rows or the odd columns will be described. A process opposite to that provided in this description may be applied to encoding the input image based on the real even image including the pixels in the even rows or the even columns.

An image filtering unit 102 may generate a predictive even image by performing predictive filtering on the real odd image using a predictive filter. When filter coefficients of the predictive filter are more optimized, the predictive even image may be almost identical to the real even image. For example, the image filtering unit 102 may use the real even image for calculating a filter coefficient of the predictive filter to be applied to the real odd image.

An image generating unit 103 may generate a differential even image by differentiating the predictive even image from the real even image. In this instance, when the filter coefficients of the predictive filter are more optimized, the differential even image may have a value relatively close to 0.

An image encoding unit 104 may encode the input image by encoding the real odd image, the differential even image, and the filter coefficients of the predictive filter. In this instance, when the filter coefficients of the predictive filter are more optimized, an amount of data of the input image to be encoded may be reduced efficiently since the differential even image may have a value relatively close to 0.

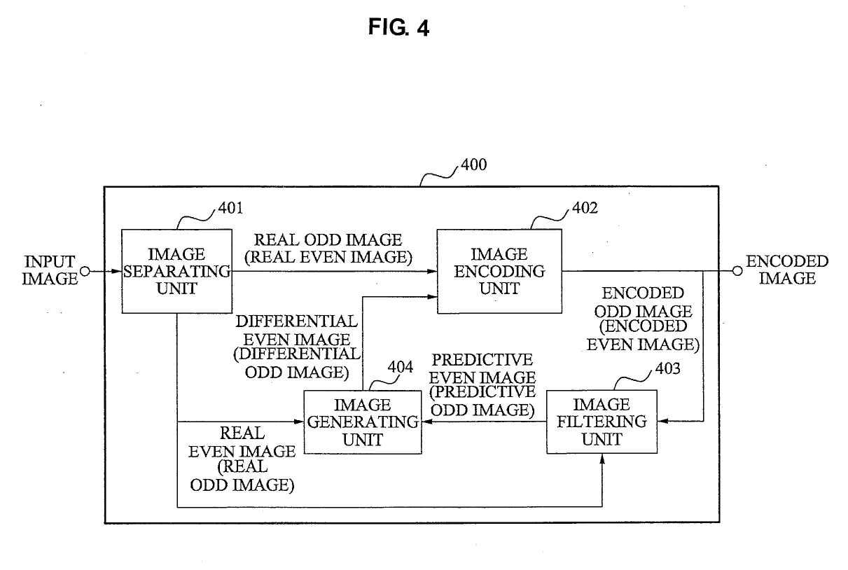

FIG. 4 illustrates a process of performing encoding based on a real odd image or a real even image according to other example embodiments.

Referring to FIG. 4, when an input image is input into an image encoding apparatus 400, an image separating unit 401 may separate the input image into a first region and a second region in pixel units. Here, the first region and the second region may correspond to, for example, a real odd image including pixels in odd rows only, or a real even image including pixels in even rows only. Also, the first region and the second region may correspond to a real even image including pixels in even columns only, or a real odd image including pixels in odd columns only.

An image encoding unit 402 may generate an encoded odd image by encoding the real odd image.

An image filtering unit 403 may generate a predictive even image by performing predictive filtering on an odd image decoded after being encoded by the image encoding unit 402, using a predictive filter. When filter coefficients of the predictive filter are more optimized, the predictive even image may be almost identical to the real even image. For example, the image filtering unit 403 may calculate the filter coefficients of the predictive filter using the odd image decoded after being encoded by the image encoding unit 402. Also, the image filtering unit 403 may calculate the filter coefficients of the predictive filter using the real image separated by the image separating unit 401.

An image generating unit 404 may generate a differential even image by differentiating the predictive even image from the real even image. In this instance, when the filter coefficients of the predictive filter are more optimized, the differential even image may have a value relatively close to 0.

The image encoding unit 402 may encode the differential even image, and may output the encoded image along with the encoded odd image.

Although it has been described that the filter coefficients are encoded, it should be understood that the description provided is an example. Accordingly, the filter coefficients may be stored along with the encoded real image and differential image or may be transmitted to another apparatus, rather than being encoded. In a case where the filter coefficients are not encoded, filter coefficients included in a header of an image encoded in an image encoding process may be extracted and may be used in an image decoding process.

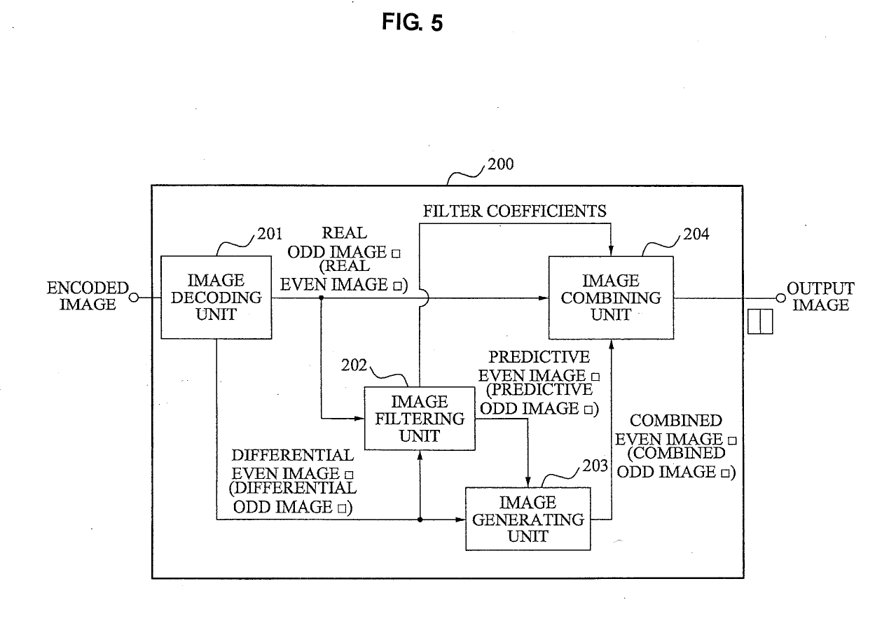

FIG. 5 illustrates a process of performing decoding based on a real odd image or a real even image according to example embodiments.

In FIG. 5, a process of decoding an encoded input image based on a real odd image including pixels in odd rows or odd columns will be described. A process opposite to that provided in this description may be applied to decoding the encoded input image based on a real even image including pixels in even rows or even columns.

An encoded input image may be input into an image decoding apparatus 200. An image decoding unit 201 may generate a real odd image, a differential even image, filter coefficients of a predictive filter, by decoding the encoded input image. An image filtering unit 202 may generate a predictive even image by filtering the real odd image using the predictive filter. That is, the more excellently the predictive filter performs, the more likely it is for the predictive even image to have a value identical to a value of the real even image.

An image generating unit 203 may generate a combined even image by combining the differential even image and the predictive even image. That is, the more excellently the predictive filter performs, the closer data of the second region excluded may become to 0. Accordingly, the real even image may be completely restored from the real odd image. An image combining unit 204 may generate an original input image by combining the real odd image and the combined even image.

FIG. 6 illustrates an image encoding apparatus according to other example embodiments.

Referring to FIG. 6, an image encoding apparatus 600 may include a predictive mode determining unit 610, a discrete cosine transform (DCT) transformation unit 620, a quantization unit 630, and an entropy encoding unit 640.

The predictive mode determining unit 610 may determine an optimal predictive mode for an input image, among a plurality of predictive modes. Here, the input image may include at least one of a real image, a differential image, and filter coefficients. The determined optimal predictive mode may correspond to a predictive mode in which the input image may be compressed most efficiently. For example, the predictive mode determining unit 610 may determine a predictive mode for which a rate-distortion cost is lowest to be the optimal predictive mode, thereby determining a predictive mode in which the compression may be performed most efficiently to be the optimal predictive mode.

The plurality of predictive modes may include a first predictive mode for performing prediction by extending an upper reference pixel in a vertical direction, a second predictive mode for performing prediction by extending a left reference pixel in a horizontal direction, a third predictive mode for performing prediction using an average of the upper reference pixel and the left reference pixel, a fourth predictive mode for not performing prediction, and a fifth predictive mode for not performing compression. Here, the first predictive mode, the second predictive mode, and the third predictive mode may correspond to a horizontal mode, a vertical mode, and a DC mode of the H.264/AVC standard, respectively.

When the optimal predictive mode determined by the predictive mode determining unit 610 corresponds to the fourth predictive mode, pixel values may be compressed intactly without performing prediction on the input image from neighboring border pixels.

When the optimal predictive mode determined by the predictive mode determining unit 610 corresponds to the fifth predictive mode, the entire process of compression for the input image may not be performed. That is, in the case of the fifth predictive mode, the entire process of prediction, DCT transformation, quantization, and entropy encoding may not be performed on the input image, and any pixel information may not be transmitted to a decoding apparatus.

The DCT transformation unit 620 may transform data of the input image from a spatial domain to a frequency domain. In this instance, as aforementioned, when the fifth predictive mode is determined to be the optimal predictive mode, the entire process of compression may not be performed and thus, the process following the DCT transformation as well as the prediction process may not be performed.

The quantization unit 630 may quantize a coefficient calculated through the DCT transformation. Here, the quantization may refer to a process of rounding off a DCT coefficient to an integer. In this process, the DCT coefficient obtained through the DCT transformation may be divided by a predetermined constant, and a resulting value may be rounded off to an integer value.

The quantization unit 630 may apply different compression rates to the real image and the differential image, by applying quantization offsets to the real image and the differential image. An amount of intra compressed bit may be dependent on a spatial homogeneity of an image. Accordingly, when the homogeneity of the image is greatly low, a correlation between an odd image and an even image may decrease as well. Accordingly, prediction may not be performed precisely and a value of a differential signal may increase. Since differential signals having relatively great values may generate a plurality of compressed bits, the differential signal may be induced to be compressed much more than a real image, for example, an odd image, by applying quantization offsets to the differential signal and the real image, for example, the odd image.

The entropy encoding unit 640 may entropically encode the coefficient quantized by the quantization unit 630 to convert the coefficient into a bit stream.

As described in the foregoing, by performing prediction using the newly defined five predictive modes, prediction efficiency may increase. Particularly, when a value of the differential signal is considerably small, pixel values may be compressed immediately without performing the prediction, and the entire process of compression may not be performed depending on an input image, whereby bit usage may decrease and encoding efficiency may increase.

FIG. 7 illustrates an image decoding apparatus according to other example embodiments. In this instance, an image decoding apparatus 700 may perform a process corresponding to a reverse of an encoding process of the image encoding apparatus 600.

Referring to FIG. 7, the image decoding apparatus 700 may include an entropy decoding unit 710, an inverse quantization unit 720, a DCT inverse transformation unit 730, and an image decoding unit 740.

The entropy decoding unit 710 may generate restoration information by entropically decoding an input bit stream.

The inverse quantization unit 720 may perform inverse quantization on the generated restoration information.

The DCT inverse transformation unit 730 may transform the inversely quantized restoration information, from a frequency domain to a spatial domain.

The image decoding unit 740 may decode a real image, a differential image, and filter coefficients by performing prediction in a predictive mode in which an encoding process is performed, among a plurality of predictive modes. Here, the plurality of predictive modes may include a first predictive mode for performing prediction by extending an upper reference pixel in a vertical direction, a second predictive mode for performing prediction by extending a left reference pixel in a horizontal direction, a third predictive mode for performing prediction using an average of the upper reference pixel and the left reference pixel, a fourth predictive mode for not performing prediction, and a fifth predictive mode for not performing compression.

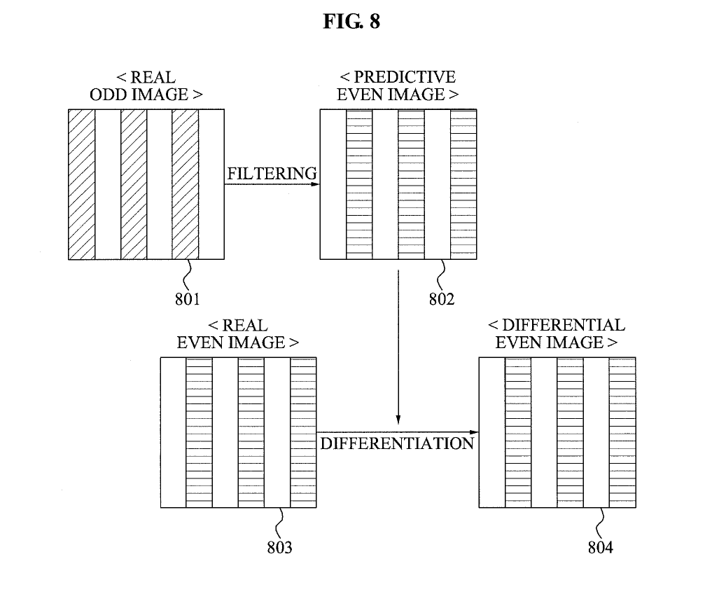

FIG. 8 illustrates a process of generating a differential even image from a real odd image according to example embodiments.

According to example embodiments, an image encoding apparatus 100 may generate a real image of a first region and a real image of a second region, in pixel units. In this instance, the first region and the second region may include pixels in columns or rows of the input image. For example, the first region and the second region may correspond to one of a real odd image and a real even image.

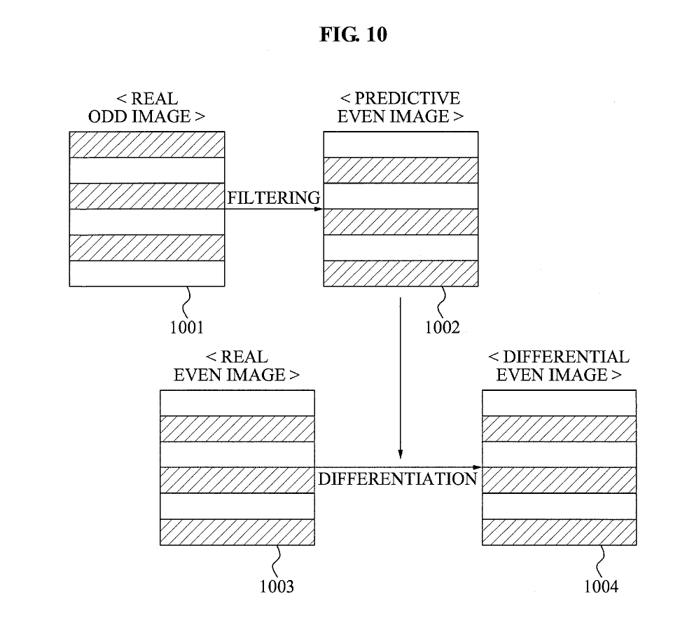

As shown in FIG. 8, a real odd image 801 may include pixels in odd rows, among pixels of the input image. Although FIG. 8 shows a process of generating a differential even image 804 from the real odd image 801 including the pixels in the odd rows, an identical process may be applied to the process may be applied identically to a real odd image including pixels in odd columns as well. A process of generating a differential even image from a real odd image including pixels in odd columns will be described later with reference to FIG. 10.

The image encoding apparatus 100 may generate a predictive even image 802 by performing predictive filtering on the real odd image using a predictive filter. In this instance, the generated predictive even image 802 may correspond to a real even image 803 including pixels in even rows of the input image. When the performance of the predictive filter is more excellent, the predictive even image 802 may be more identical to the real even image 803.

The image encoding apparatus 100 may generate the differential even image 804 by differentiating the predictive even image 802 from the real even image 803. As aforementioned, when the performance of the predictive filter is more excellent, the differential even image 804 may have a value relatively close to 0 since the predictive even image 802 may be more identical to the real even image 803. In other words, when the value of the differential even image 804 is relatively close to 0, an amount of data for encoding the input image may be reduced by half of an amount of data of the entire input image. The image encoding apparatus 100 may encode the real odd image 801, the differential even image 804, and filter coefficients of the predictive filter.

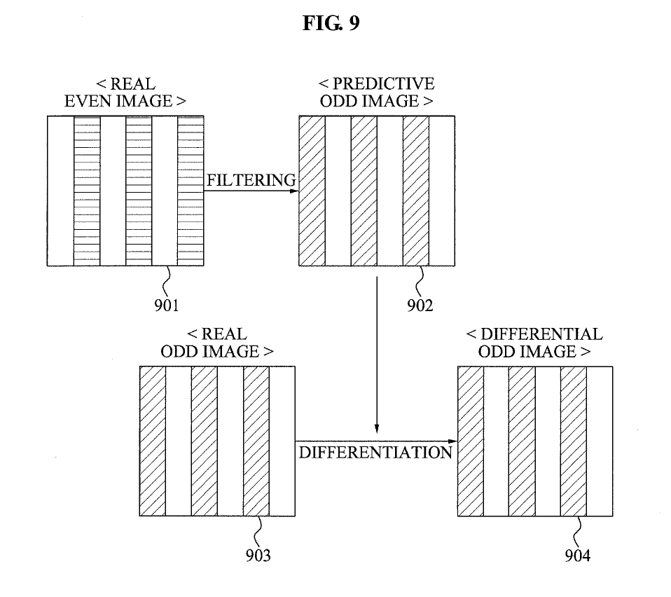

FIG. 9 illustrates a process of generating a differential odd image from a real even image according to example embodiments.

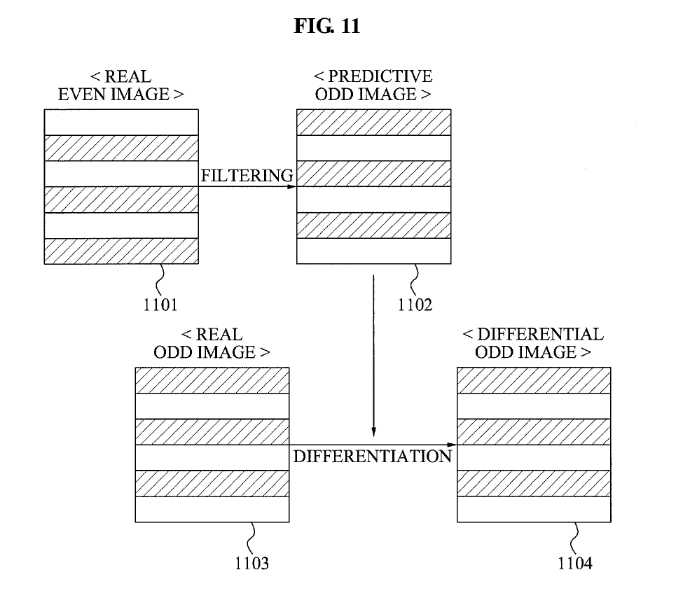

As shown in FIG. 9, a real even image 901 may include pixels in even rows, among pixels of an input image. Although FIG. 9 shows a process of generating a differential odd image 904 from the real even image 901 including the pixels in the even rows, (*an identical process may be applied to? the process may be applied identically to a real even image including pixels in even columns. A process of generating a differential odd image from a real even image including pixels in even columns will be described later with reference to FIG. 11.

An image encoding apparatus 100 may generate a predictive odd image 902 by performing predictive filtering on the real even image 901 using a predictive filter. In this instance, the generated predictive odd image 902 may correspond to a real odd image 903 including pixels in odd rows of the input image. That is, the more excellently the predictive filter performs, the more identical the predictive odd image 902 may become to the real odd image 903.

The image encoding apparatus 100 may generate the differential odd image 904 by differentiating the predictive odd image 902 from the real odd image 903. As aforementioned, the more excellently the predictive filter performs, the closer the differential odd image 904 may become to 0, since the predictive odd image 902 may be more identical to the real odd image 903. In other words, when the value of the differential odd image 904 becomes closer to 0, an amount of data for encoding the input image may be reduced by half of an amount of data of the entire input image. The image encoding apparatus 100 may encode the real even image 901, the differential odd image 904, and filter coefficients of the predictive filter.

FIG. 10 illustrates a process of generating a differential even image from a real odd image according to other example embodiments.

In FIG. 10, a process of generating a differential even image 1004 from a real odd image 1001 including pixels in odd columns is illustrated.

An image encoding apparatus 100 may generate a predictive even image 1002 by performing predictive filtering on the real odd image 1001 using a predictive filter. In this instance, the generated predictive even image 1002 may correspond to a real even image 1003 including pixels in even columns of the input image. That is, the more excellently the predictive filter performs, the more identical the predictive even image 1002 may become to the real even image 1003.

The image encoding apparatus 100 may generate the differential even image 1004 by differentiating the predictive even image 1002 from the real even image 1003. As aforementioned, when the performance of the predictive filter is more excellent, the differential even image 1004 may have a value relatively close to 0 since the predictive even image 1002 may be more identical to the real even image 1003. The image encoding apparatus 100 may encode the real odd image 1001, the differential even image 1004, and filter coefficients of the predictive filter.

FIG. 11 illustrates a process of generating a differential odd image from a real even image according to other example embodiments.

As shown in FIG. 11, a real even image 1101 may include pixels in even columns, among pixels of an input image. In FIG. 11, a process of generating a differential odd image 1104 from the real even image 1101 including the pixels in the even columns is illustrated.

An image encoding apparatus 100 may generate a predictive odd image 1102 by performing predictive filtering on the real even image 1101 using a predictive filter. In this instance, the generated predictive odd image 1102 may correspond to a real odd image 1103 including pixels in odd columns of the input image. When the performance of the predictive filter is more excellent, the predictive odd image 1102 may be more identical to the real odd image 1103.

The image encoding apparatus 100 may generate the differential odd image 1104 by differentiating the predictive odd image 1102 from the real odd image 1103. As aforementioned, the more excellently the predictive filter performs, the more the differential odd image 1104 may become closer to 0, since the predictive odd image 1102 may be more identical to the real odd image 1103. In other words, when the value of the differential odd image 1104 is relatively close to 0, an amount of data for encoding the input image may be reduced by half of an amount of data of the entire input image. The image encoding apparatus 100 may encode the real even image 1101, the differential odd image 1104, and filter coefficients of the predictive filter.

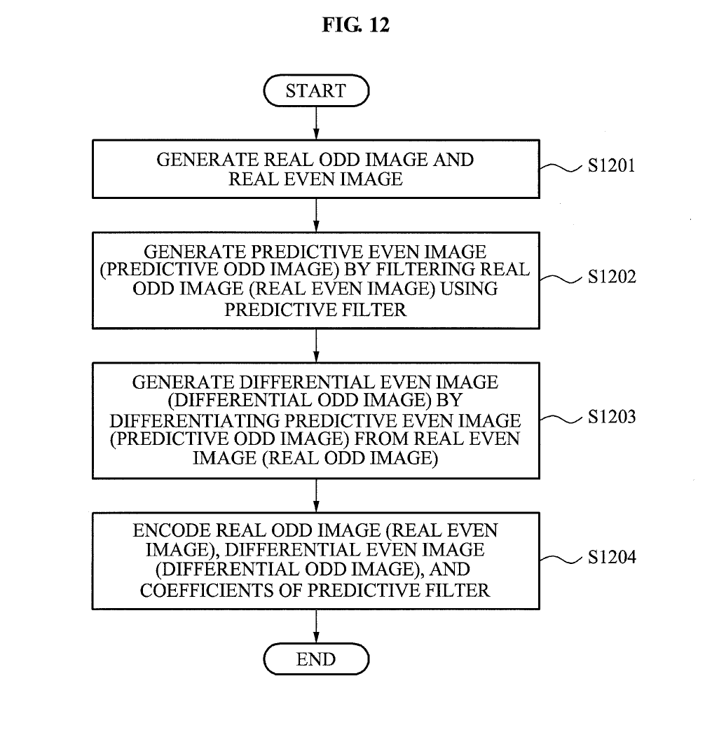

FIG. 12 illustrates an image encoding method according to example embodiments.

FIG. 12 illustrates a process of encoding an input image using a real odd image, and a process of encoding an input image using a real even image may be applied in an identical manner.

In operation S1201, an image encoding apparatus may generate a real odd image and a real even image in pixel units. In this instance, the real odd image may refer to an image including pixels in odd rows or odd columns of the input image, and the real even image may refer to an image including pixels in even rows or even columns of the input image.

In operation S1202, the image encoding apparatus may generate a predictive even image by performing predictive filtering on the real odd image using a predictive filter. For example, the image encoding apparatus may calculate a filter coefficient by which the real even image may be most precisely predicted from the real odd image, and may apply, to the real odd image, a predictive filter to which the calculated filter coefficient is applied.

In another example, the image encoding apparatus may generate a predictive odd image by performing predictive filtering on the real even image using the predictive filter.

In operation S1203, the image encoding apparatus may generate a differential even image by differentiating, from the real even image, the predictive even image generated through the predictive filtering. That is, the more excellently the predictive filter performs, the closer data of the second region excluded may become to 0, since the predictive even image may have a value almost identical to a value of the real even image.

In the other example, the image encoding apparatus may generate a differential odd image by differentiating the predictive odd image from the real odd image.

In operation S1204, the image encoding apparatus may encode the real odd image, the differential even image, and the filter coefficients of the predictive filter. In the other example, the image encoding apparatus may encode the real even image, the differential odd image, and the filter coefficients of the predictive filter.

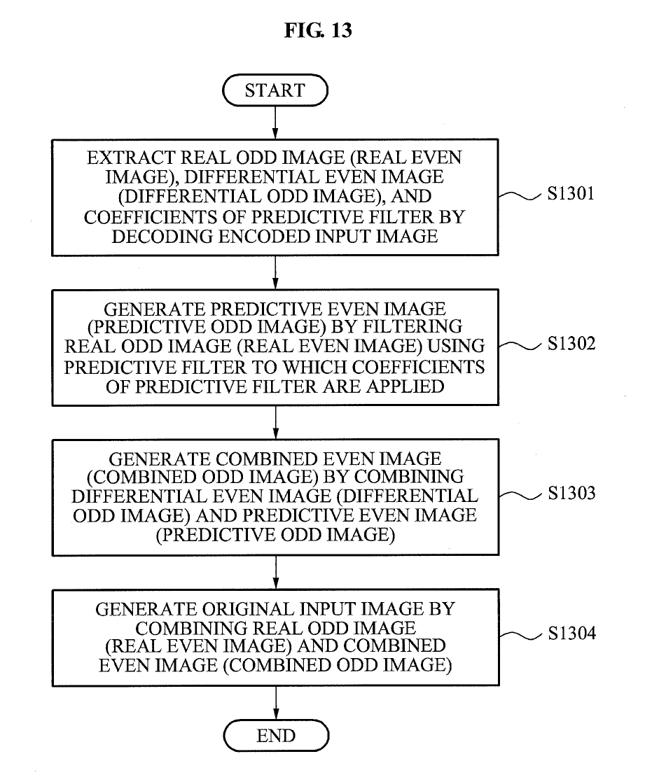

FIG. 13 illustrates an image decoding method according to example embodiments.

In operation S1301, an image decoding apparatus may extract a real odd image, a differential even image, and filter coefficients of a predictive filter by decoding an encoded input image. In another example, the image decoding apparatus may extract a real even image, a differential odd image, and the filter coefficients of the predictive filter by decoding the encoded input image.

In operation S1302, the image decoding apparatus may generate a predictive even image by performing predictive filtering on the real odd image using the predictive filter. In the other example, the image decoding apparatus may generate a predictive odd image by performing predictive filtering on the real even image using the predictive filter.

In operation S1303, the image decoding apparatus may generate a combined even image by combining the differential even image and the predictive even image. In the other example, the image decoding apparatus may generate a combined odd image by combining the differential odd image and the predictive odd image.

In operation S1304, the image decoding apparatus may generate an original input image by combining the real odd image and the combined even image. In the other example, the image decoding apparatus may generate an original input image by combining the real even image and the combined odd image.

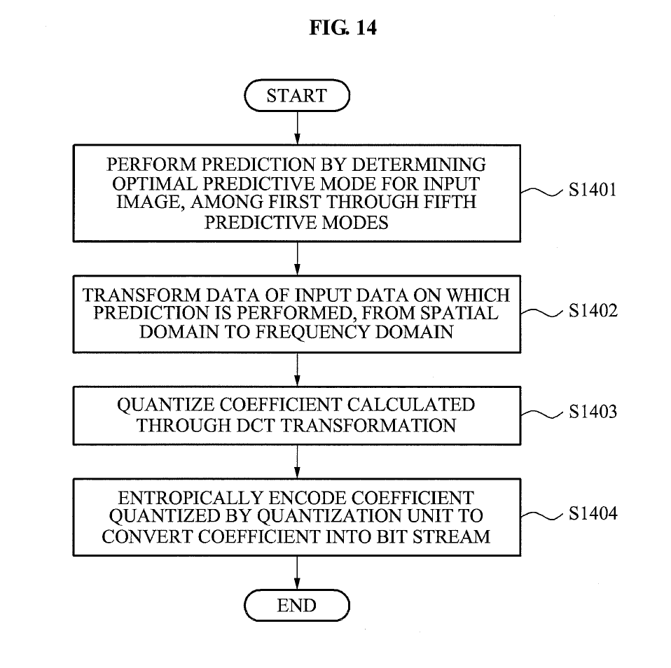

FIG. 14 illustrates an image encoding method according to other example embodiments.

Referring to FIG. 14, in operation S1401, an image encoding apparatus may determine an optimal predictive mode for an input image, among a first predictive mode, a second predictive mode, a third predictive mode, a fourth predictive mode, and a fifth predictive mode, and may perform prediction based on the determined optimal predictive mode. In this instance, the first through predictive mode, the second predictive mode, the third predictive mode, the fourth predictive mode, and the fifth predictive mode may correspond to a first predictive mode for performing prediction by extending an upper reference pixel in a vertical direction, a second predictive mode for performing prediction by extending a left reference pixel in a horizontal direction, a third predictive mode for performing prediction using an average of the upper reference pixel and the left reference pixel, a fourth predictive mode for not performing prediction, and a fifth predictive mode for not performing compression, respectively. That is, the operation S1401 for the prediction process may not be performed in the fourth predictive mode, and the entire operations for the prediction through compression process, S1401, S1402, S1403, and S1404 may not be performed in the fifth predictive mode.

In operation S1402, the image encoding apparatus may transform data of the input image on which the prediction is performed, from a spatial domain to a frequency domain.

In operation S1403, the image encoding apparatus may quantize a coefficient calculated through a DCT transformation. Accordingly, the coefficient calculated through the DCT transformation may be rounded off to an integer.

Also, as aforementioned, in the quantization process, different compression rates may be applied to a real image and a differential image, by applying quantization offsets to the real image and the differential image.

In operation S1404, the image encoding apparatus may entropically encode the coefficient quantized by a quantization unit to convert the coefficient into a bit stream.

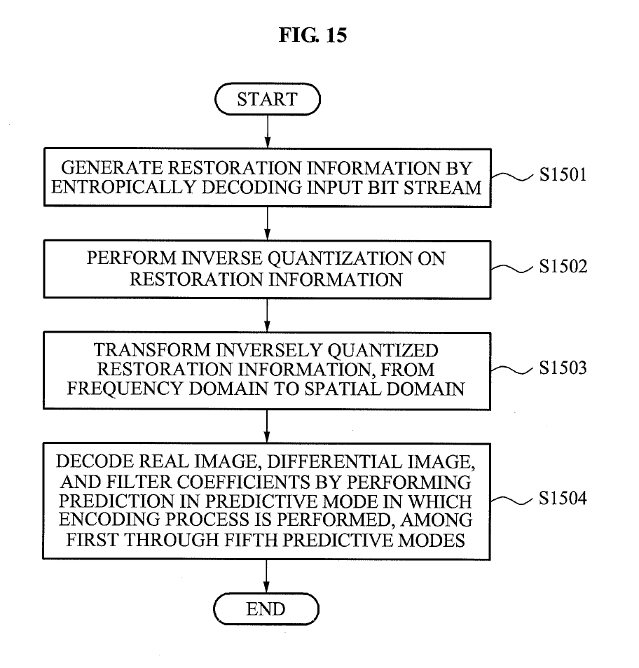

FIG. 15 illustrates an image decoding method according to other example embodiments.

Referring to FIG. 15, in operation S1501, an image decoding apparatus may generate restoration information by entropically decoding an input bit stream.

In operation S1502, the image decoding apparatus may perform inverse quantization on the generated restoration information. In operation S1503, the image decoding apparatus may transform the inversely quantized restoration information, from a frequency domain to a spatial domain.

In operation S1504, the image decoding apparatus may decode a real image, a differential image, and filter coefficients by performing prediction in a predictive mode in which an encoding process is performed, among the aforementioned first predictive mode, second predictive mode, third predictive mode, fourth predictive mode, and fifth predictive mode.

The descriptions of FIGS. 1 through 11 may be referred to for descriptions omitted with respect to FIGS. 12 through 15.

In the foregoing, although it has been described that five predictive modes are used for a real image and a differential image, it may not be limited thereto. As other example embodiments, a predictive mode that is used in the H.264/AVC standard published by International Telecommunications Union-Telecommunication (ITU-T) in March 2009 may be used for the real image, and the five predictive modes described herein may be used for the differential image.

The image encoding method or the image decoding method according to example embodiments includes computer-readable media including program instructions to implement various operations embodied by a computer. The media may also include, alone or in combination with the program instructions, data files, data structures, tables, and the like. The media and program instructions may be those specially designed and constructed for the purposes of example embodiments, or they may be of the kind well known and available to those having skill in the computer software arts. Examples of computer-readable media include magnetic media such as hard disks, floppy disks, and magnetic tape; optical media such as CD ROM discs; magneto-optical media such as floptical discs; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

Although a few example embodiments have been shown and described, the present disclosure is not limited to the described example embodiments. Instead, it would be appreciated by those skilled in the art that changes may be made to these example embodiments without departing from the principles and spirit of the disclosure, the scope of which is defined by the claims and their equivalents.

1. An image encoding apparatus comprising:
an image filtering unit to generate a predictive image of a second region different from a first region by performing predictive filtering on a real image of the first region of an input image using a predictive filter;
an image generating unit to generate a differential image of the second region, using the predictive image of the second region and a real image of the second region; and
an image encoding unit to encode the real image of the first region and the differential image of the second region.

2. The apparatus of claim 1, further comprising:
an image separating unit to generate the real image of the first region and the real image of the second region, with respect to the input image,
wherein the image separating unit generates a real even image including pixels in even rows or even columns and a real odd image including pixels in odd rows or odd columns, with respect to the input image.

3. The apparatus of claim 2, wherein
the image filtering unit generates a predictive odd image by filtering the real even image using the predictive filter when the pixels in the even rows or the even columns of the input image are encoded, and
the image generating unit generates a differential odd image by differentiating the predictive odd image from the real odd image.

4. The apparatus of claim 2, wherein
the image filtering unit generates a predictive even image by filtering the real odd image using the predictive filter when the pixels in the odd rows or the odd columns of the input image are encoded, and
the image generating unit generates a differential even image by differentiating the predictive even image from the real even image.

5. The apparatus of claim 3, wherein
the image encoding unit encodes the real even image and the differential odd image when the pixels in the even rows or the even columns of the input image are encoded, and
the image encoding unit encodes the real odd image and the differential even image when the pixels in the odd rows or the odd columns of the input image are encoded.

6. An image encoding apparatus comprising:
an image encoding unit to encode a real image of a first region of an input image;
an image filtering unit to generate a predictive image of a second region different from the first region, by performing predictive filtering on the real image of the first region using a predictive filter; and
an image generating unit to generate a differential image of the second region, using the predictive image of the second region and a real image of the second region,
wherein the image encoding unit encodes the differential image of the second region.

7. An image encoding apparatus comprising:
an image filtering unit to generate a predictive image of a second region of an input image, by performing predictive filtering on a real image of a first region of the input image using a predictive filter;
an image generating unit to generate a differential image of the second region, using the predictive image of the second region and a real image of the second region; and
an image encoding unit to perform encoding by applying quantization offsets to at least one of the real image of the first region, the differential image of the second region, and filter coefficients of the predictive filter.

8. The apparatus of claim 7, wherein the image encoding unit performs intra predictive encoding in at least one of a first predictive mode for performing prediction by extending an upper reference pixel in a vertical direction, a second predictive mode for performing prediction by extending a left reference pixel in a horizontal direction, a third predictive mode for performing prediction using an average of the upper reference pixel and the left reference pixel, a fourth predictive mode for not performing prediction, and a fifth predictive mode for not performing compression.

9. An image encoding apparatus comprising:
a predictive mode determining unit to determine an optimal predictive mode for an input image among a first predictive mode for performing prediction by extending an upper reference pixel in a vertical direction, a second predictive mode for performing prediction by extending a left reference pixel in a horizontal direction, a third predictive mode for performing prediction using an average of the upper reference pixel and the left reference pixel, a fourth predictive mode for not performing prediction, and a fifth predictive mode for not performing compression, and to perform prediction for the input image based on the determined optimal predictive mode;
a discrete cosine transform (DCT) transformation unit to transform data of the input image on which the prediction is performed, from a spatial domain to a frequency domain;
a quantization unit to quantize a coefficient calculated through the DCT transformation; and
an entropy encoding unit to entropically encode the coefficient quantized by the quantization unit to convert the coefficient into a bit stream.

10. The apparatus of claim 9, wherein the predictive mode determining unit determines a predictive mode for which a rate-distortion cost is lowest to be the optimal predictive mode.

11. The apparatus of claim 9, wherein
the input image comprises at least one of a real image and a differential image, and
the quantization unit applies quantization offsets to the real image and the differential image.

12. The apparatus of claim 9, wherein
prediction is not performed on the input image when the determined optimal predictive mode corresponds to the fourth predictive mode, and
prediction, DCT transformation, quantization, and entropy encoding are not performed on the input image when the determined optimal predictive mode corresponds to the fifth predictive mode.

13. An image decoding apparatus comprising:
an image decoding unit to decode a real image of a first region and a differential image of a second region different from the first region, with respect to an encoded input image;
an image filtering unit to generate a predictive image of the second region by performing predictive filtering on the real image of the first region;
an image generating unit to generate a combined image of the second region, using the predicative image of the second region and the differential image of the second region; and
an image combining unit to generate an original input image by combining the real image of the first region and the combined image of the second region.

14. The apparatus of claim 13, wherein
the image decoding unit decodes a real even image and a differential odd image when pixels in even rows or even columns of the input image are encoded, and
the image decoding unit decodes a real odd image and a differential even image when pixels in odd rows or odd columns of the input image are encoded.

15. The apparatus of claim 14, wherein
the image filtering unit generates a predictive odd image by filtering the real even image using a predictive filter when the pixels in the even rows or even columns of the input image are encoded, and
the image generating unit generates a combined odd image by combining the differential odd image and the predictive odd image.

16. The apparatus of claim 14, wherein
the image filtering unit generates a predictive even image by filtering the real odd image using a predictive filter when the pixels in the odd rows or odd columns of the input image are encoded, and
the image generating unit generates a combined even image by combining the differential even image and the predictive even image.

17. The apparatus of claim 15, wherein
the image combining unit generates the original input image by combining the real even image and the combined odd image when the pixels in the even rows or even columns of the input image are encoded, and
the image combining unit generates the original input image by combining the real odd image and the combined even image when the pixels in the odd rows or odd columns of the input image are encoded.

18. An image decoding apparatus comprising:
an image decoding unit to decode a real image of a first region and a differential image of a second region different from the first region, with respect to an input image encoded by applying quantization offsets;
an image filtering unit to generate a predictive image of the second region by performing predictive filtering on the real image of the first region;
an image generating unit to generate a combined image of the second region, using the predictive image of the second region and the differential image of the second region; and
an image combining unit to generate an original input image by combining the real image of the first region and the combined image of the second region.

19. The apparatus of claim 18, wherein the image decoding unit decodes a real image and a differential image by performing prediction in a predictive mode in which an encoding process is performed, among a first predictive mode for performing prediction by extending an upper reference pixel in a vertical direction, a second predictive mode for performing prediction by extending a left reference pixel in a horizontal direction, a third predictive mode for performing prediction using an average of the upper reference pixel and the left reference pixel, a fourth predictive mode for not performing prediction, and a fifth predictive mode for not performing compression.

20. An image decoding apparatus comprising:
an entropy decoding unit to generate restoration information by entropically decoding an input bit stream;
an inverse quantization unit to perform inverse quantization on the generated restoration information;
a discrete cosine transform (DCT) inverse transformation unit to transform the inversely quantized restoration information, from a frequency domain to a spatial domain; and
an image decoding unit to decode a real image and a differential image by performing prediction in a predictive mode in which an encoding process is performed, among a first predictive mode for performing prediction by extending an upper reference pixel in a vertical direction, a second predictive mode for performing prediction by extending a left reference pixel in a horizontal direction, a third predictive mode for performing prediction using an average of the upper reference pixel and the left reference pixel, a fourth predictive mode for not performing prediction, and a fifth predictive mode for not performing compression.
